(19) United States
(12) Patent Application Publication
(10) Pub. No.: US 2026/0340221 A1
(43) Pub. Date: Oct. 29, 2026

(54) TRUST SCORING FRAMEWORK INTEGRATION WITH DIGITAL TWINS WITH AND WITHOUT FLOW NETWORK AUGMENTATION

(71) Applicant: Dell Products L.P., Round Rock, TX (US)

(72) Inventors: Deepak Gaikwad, Natick, MA (US); Judith A. Furlong, Natick, MA (US); Raj Suryavanshi, Leander, TX (US); Said Tabet, Austin, TX (US)

(21) Appl. No.: 19/188,805

(22) Filed: Apr. 24, 2025

(51) Int. Cl. G06F 30/20; H04L 9/40

(52) U.S. Cl. CPC G06F 30/20; H04L 63/20

(57) ABSTRACT

One example method for assessing aspects of a physical zero trust (ZT) environment and identifying corresponding actions to be taken with respect to the physical ZT environment includes, creating a representation of the physical ZT environment, and the representation comprises one or more digital twins that each correspond to a respective component of the physical ZT environment, monitoring, with the digital twins, the components and operation of the physical ZT environment, collecting, by the digital twins, data concerning the components and the operation of the physical ZT environment, and implementing, automatically, a change to the physical ZT environment based on the data collected by the digital twins.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to trust scoring frameworks. More particularly, at least some embodiments relate to systems, hardware, software, computer-readable media, and methods, for generating trust information and a trust posture of a system and its components.

### BACKGROUND

Zero Trust (ZT) environments are complex and synchronization between different components of a ZT environment creates challenges, one of which is that all the interactions in the ZT environment are taking place dynamically. The various respective behaviors of the components of a ZT environment are diverse and require potentially different models and algorithms to represent them accurately. This complexity is exacerbated by the new types of workloads focused on AI, which may involve, different modalities for example. Configuration and management of the ZT environment is policy driven, but due to the complexity of the relationships between the entities in the ZT environment and the dynamic operational changes, compliance for the policies require continuous monitoring to maintain a minimum acceptable threshold of trust.

Moreover, with the advent of AI (artificial intelligence) and new requirements from various sectors, IT (information technology) environments are becoming more complex. The more stringent security requirements imposed by applying ZT principles to the IT environment adds to this complexity. In current ZT architectures, observability and monitoring tends to emphasize on IAM (identity and access management) and data flows. Additionally, traditional ML (machine learning) techniques based on correlation often will miss certain threats, and potential remediation solutions and opportunities, when variables and unknowns external/exogeneous to the ZT environment are the ones influencing the change in security posture. Examples include environmental variables, and excessive energy consumption when all systems are healthy.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a trust scoring framework integrated with a digital twin, according to one embodiment.

FIG. 2 discloses aspects of flow networks for representing complex ZT environments, according to one embodiment.

FIG. 3 discloses a flow network-based digital twin of a ZT environment for real time security posture, according to one embodiment.

FIG. 4 discloses aspects of an example method according to one embodiment.

FIG. 5 discloses an example computing entity configured and operable to perform any of the disclosed methods, processes, and operations.

### DETAILED DESCRIPTION OF SOME EXAMPLE EMBODIMENTS

Some embodiments disclosed herein generally relate to the use of trust scoring frameworks as one mechanism to determine, and maintain, a security posture of a ZT environment. For example, some embodiments comprise integration of a trust scoring framework with digital twins both with, and without, flow network augmentation of the digital twins. Yet other embodiments comprise flow networks that represent complex ZT environments. Further embodiments comprise a flow network-based digital twin of a ZT environment for real-time security posture. A flow network may represent a portion of a ZT environment, such as a component of the ZT environment, and may be incorporated as an element of a digital twin that represents that portion of the ZT environment. Following is a brief overview of some aspects of various embodiments.

One embodiment comprises a method, schema, and architecture for integration of component TSFs (trust scoring framework) with component digital twins of a ZT environment. The digital twin of the ZT environment comprises respective digital twins of components of the ZT environment. Each of the digital twins may be implemented as, or at least comprise, an ML model, and each digital twin corresponds to a respective TSF. In this way, each digital twin contributes to an assessment/validation of a trust score for the component to which that digital twin corresponds. In operation, the individual TSFs may provide their respective security assessments, of the ZT components to which they correspond, to a TSF score aggregation service, which may then aggregate these assessments into a single, overall, system level trust posture. In an embodiment, the trust scores generated by a TSF may be generated based not only on information and data gathered by the TSF itself, but also based on information and data gathered by a digital twin concerning the ZT component that the digital twin represents. In this way, the TSF has access to a relatively richer set of data concerning the ZT environment than what the TSF would be able to obtain on its own. A system level trust posture generated by a TSF score aggregation service may be used for example, in troubleshooting the ZT environment to identify problems, and implementing, possibly automatically, corresponding remedial actions with respect to the ZT environment and one or more of its components.

Another embodiment comprises a method, schema, and architecture for a flow network that may be used to represent a ZT environment, or a portion of a ZT environment. The structure, relationships, and components, of a ZT environment may be modeled with a digital twin, or digital twins, that includes the flow network. The structure, at least, may be used as an input to a model that generates a flow network that represents a portion of the ZT environment. In this flow network, each component of the ZT network may be represented as a respective node, and a flow network module within the digital twin may be used to monitor the flow network, including the various paths between the nodes of the flow network. Information obtained during the monitoring of the flow network(s) may be used for various purposes including, but not limited to, identifying potential vulnerabilities, ZT policy drift, obtaining insights into an overall security posture of the ZT environment, and dynamically applying changes in the physical ZT environment to address any problems and vulnerabilities detected. In various embodiments, a digital twin may be implemented and used with, or without, a flow network that corresponds to a ZT component or region to which the digital twin also corresponds. When incorporated in a digital twin, a flow network may provide a relatively more granular view of a ZT component or region than what can be provided by the digital twin alone.

A further example embodiment comprises a method, schema, and architecture for a flow network-based digital twin of a ZT environment for obtaining real-time security posture information concerning the ZT environment. In this example embodiment, a flow network may be used to represent a ZT environment or portion thereof, and a digital twin of the ZT environment may monitor, using a monitoring engine that may be an element of the digital twin, a physical state of the ZT environment in real time. The flow network representation may be used by the monitoring engine to determine a current state of the physical ZT environment with respect, for example, to environmental threats, power consumption, and other parameters. Anomalies, such as values exceeding an established threshold for example, may be identified as possible problems or threats. The monitoring process may include use of a trust score framework to assign risk scores to systems of the ZT environment that are running workloads. The risk scores may be used to control operation of the systems and to support the investigation of anomalies. The digital twin may be continuously synchronized with the ZT environment at a specified frequency, to ensure that the digital twin is up to date and reflects changes occurring in the ZT environment.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an embodiment may generate a real-time assessment of the current posture of a ZT environment. An embodiment may provide just-in-time (JIT) management of ZT policies. An embodiment may generate a flow network representation of a ZT environment that may enable real-time monitoring, and modifying if necessary, of the security and operations of that ZT environment. An embodiment may use generative flow network representations to decouple, and implement policy changes with respect to, the more dynamic aspects of a ZT environment. Various other advantages of one or more example embodiments will be apparent from this disclosure.

### A. Digital twin of a physical ZT, integrated with a trust scoring framework

One example embodiment comprises an integration of a trust scoring framework with a digital twin of a ZT environment, or component of a ZT environment. The digital twin may be configured to mimic the configuration and operation of a real world environment such as a ZT environment. As employed in an embodiment, such a digital twin may be useful in obtaining insights about the ZT environment, but the digital twin does so in such a way that it does not compromise or interfere with the operations conducted in the ZT environment.

A digital twin according to one or more embodiments may be implemented as set forth in https://www.digitaltwinconsortium.org/initiatives/the-definition-of-a-digital-twin/. This document is incorporate herein in its entirety by this reference.

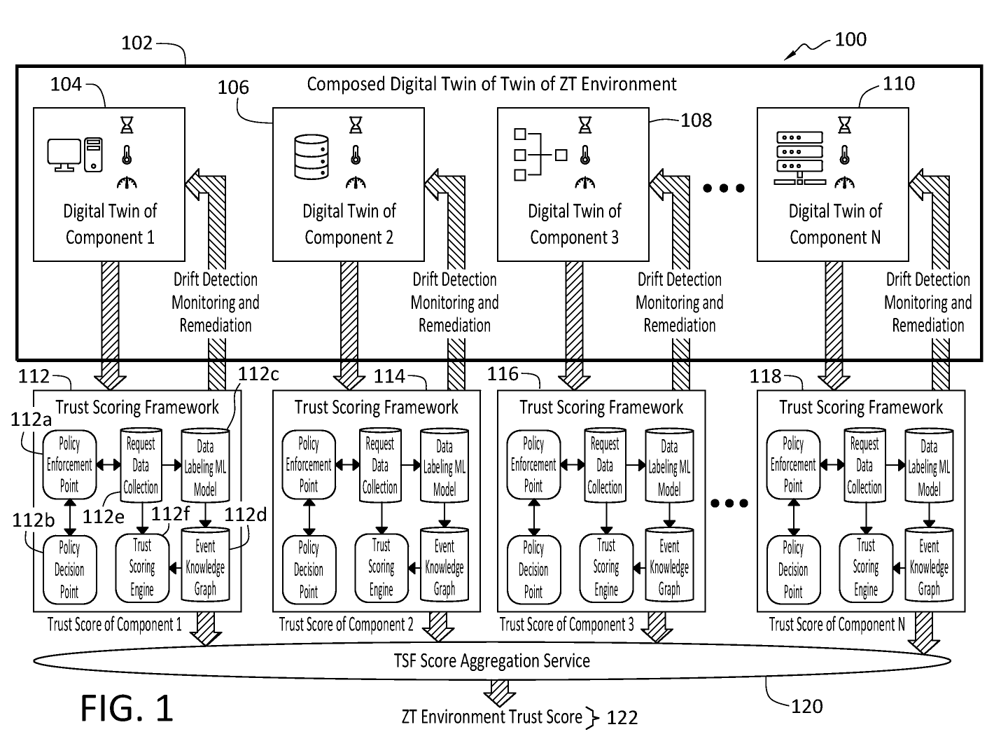

With reference now to the example of FIG. 1, a schema 100 according to one embodiment is disclosed. As shown, a composite digital twin, or simply ‘DT,’ 102 may be created that is a digital twin of an environment, such as a ZT environment (not shown) for example. The ZT environment itself may comprise a variety of components such as, but not limited to, software, servers, edge devices, autonomous vehicles, IoT (internet of things) devices, data storage, networks, and various computing systems and entities. Thus, the DT 102 may comprise a respective component digital twin (CDT) 104, 106, 108, and 110, for respective corresponding components of the ZT environment. There is no limit to the size, composition, or configuration of the ZT environment and corresponding DT 102.

As further indicated in the example of FIG. 1, each of the CDTs 104, 106, 108, and 110 may be associated with a respective trust scoring framework (TSF) 112, 114, 116, and 118. Herein, the TSFs collectively provide the ability to generate a trust posture of the ZT environment, and each individual TSF 112, 114, 116, and 118 operates to generate a trust posture of the respective ZT component, or simply ‘component,’ that is mimicked or represented by each of DT 104, 106, 108, and 110. That is, in an embodiment, the structure of the DT 102, or overall digital twin, is described at the TSF level, with each component of the digital twin contributing to the overall trust posture of the system. Among other things, a TSF may implement a drift detection monitoring system, and functions, that may be used to manage the behavior of each DT 102 model at the individual component level, testing for hallucinations, and both data and concept drift. This approach lends desirable granularity to the monitoring of the ZT environment, at least insofar as the digital twin, in conjunction with a TSF, provides identification of an individual component, for example, as problematic and in need of some type of remediation.

With continued reference to FIG. 1, and the example TSF 112, the behavior of each of the components of the ZT environment may be modeled using a respective digital twin model, such as an AI/data driven model. As shown, the TSF 112 may comprise various nodes or elements, and functions. These may include, but are not limited to, a policy enforcement point (PEP) 112a, a policy decision point (PDP) 112b, a data labeling ML model 112c, an event knowledge graph 112d, a data collection request module 112e, and a trust scoring engine 112f. The TSFs 114, 116, and 118, may be similarly configured.

Internally, the TSF 112 may perform various operations. For example, based on the monitoring of the CDT 104, a PDP 112b may be reached that requires some type of action be performed with respect to the operation of the DT 104, and this policy may be enforced by the PEP 112a, such as by remediation instructions sent to the DT 104. Data collection operations may be performed by the data collection request module 112e concerning any aspect of operations performed by the TSF 112 and the CDT 104, and collected data may be labeled by the data labeling ML model 112c. In an embodiment, an event knowledge graph 112d may be created, or modified, to reflect events occurring with respect to the DT 104. Finally, based at least in part on data collected concerning the CDT 104, the trust scoring engine 112f may assign a new or modified trust score to the DT 104. For example, if the data collected concerning the DT 104 indicates a possible security breach, the trust scoring engine 112f may assign a relatively low, or decreased, trust score to the DT 104.

Thus, as shown in FIG. 1, the TSF 112 may operate in a feedback loop with the DT 104. In particular, the TSF 112 may monitor the operations of the CDT 104 and collect data concerning those operations. That data may then be processed by the TSF 112, such as described above, and used to identify and implement appropriate remedial, or other, actions in the DT 104. This loop of operations may be performed on an ongoing basis, possibly in real-time as the ZT environment conducts its operations, to implement real-time monitoring and control of a component of a physical ZT environment by real-time, live, updates to the CDT corresponding to that component.

In an embodiment, the component of the physical ZT environment may not be updated immediately, or updated at all, such as in a testing or what-if scenarios. In this way, a potential remedy, for example, may be tested in the DT 102 environment before actually being implemented in the physical ZT environment. If the testing indicates changes are needed, those changes can be implemented before the remedy or other action is pushed out to the physical ZT environment. In this way, updates can be identified and tested without impairing ongoing production operations in the physical ZT environment, which may be taking place simultaneously with the testing.

At scheduled times, randomly, or continuously, for example, each TSF 112, 114, 116, and 118, which may each take the form of a respective ML model, may generate and push out a respective trust score generated for its associated DT 102 component to a TSF score aggregation service 120. This TSF score aggregation service 120 may then aggregate the various trust scores received from each of the individual TSFs into a single system level trust posture, reflected by a ZT environment trust score 122. In this way, an aggregate view of the overall posture of the physical environment to which the DT 102 corresponds may be generated.

As disclosed herein, an embodiment may possess various useful features and aspects, although no embodiment is required to possess any of such features or aspects. The following examples are illustrative, but not exhaustive.

Composability of digital twins of a ZT environment enables a higher level of precision of trust, at the individual component level of the ZT environment, so that the output quantified by an embodiment is representative in real time of the current posture of multiple different dimensions of the ZT environment, and of the ZT environment as a whole. As another example, an embodiment enables management of the granularity of the ZT environment monitoring data by analyzing at the component level datasets. Because data sets are reduced in size by an embodiment, the compute environment, comprising the CDTs and individual TSFs, to monitor the ZT environment can be optimized both in terms of its size, and its resource consumption. Further, such composability enables a reduction in the frequency of drift of the DT model(s). The general drift of the larger aggregate model, such as the DT 102, may also be reduced by an embodiment. An embodiment may enable use of smaller digital twin models, such as per-component or at some other level of granularity, which collectively represent the overall physical ZT environment. This reduction in digital twin model size translates into a reduction of the compute resources and model data necessary for the model to run efficiently. Finally, an embodiment provides JIT management of ZT policies.

### B. Flow networks to represent complex ZT environments

One example embodiment comprises the creation and use of a data structure, specifically, a generative flow network that comprises a generative ML model, to represent a complex ZT environment. A flow network may be based on, and/or comprise, graphs. As contemplated herein, a flow network embraces, but is not limited to, a directed graph where edges represent a ‘flow’ between nodes of the graph, where each node corresponds to a respective entity of a ZT environment. A flow network may also be referred to as a ‘transportation network’ and may be used by embodiments to model and represent the flow of different types of resources, such as data for example, within a ZT environment. For this reason, at least, a flow network may provide a relatively more granular view of a ZT environment, including its structure, operations, and relationships, than can be provided by a digital twin alone.

Generative flow networks, which are a recent extension of the flow network concept, are considered a new generation of machine learning and neural network algorithms that use a graph-based representation to model complex objects, such as a ZT environment for example, and their composition, or ZT components, and interactions, such as between ZT components. Generative flow networks offers a promising approach for representing, through its structure, the causal components and the structure and behavioral elements of a complex ZT environment.

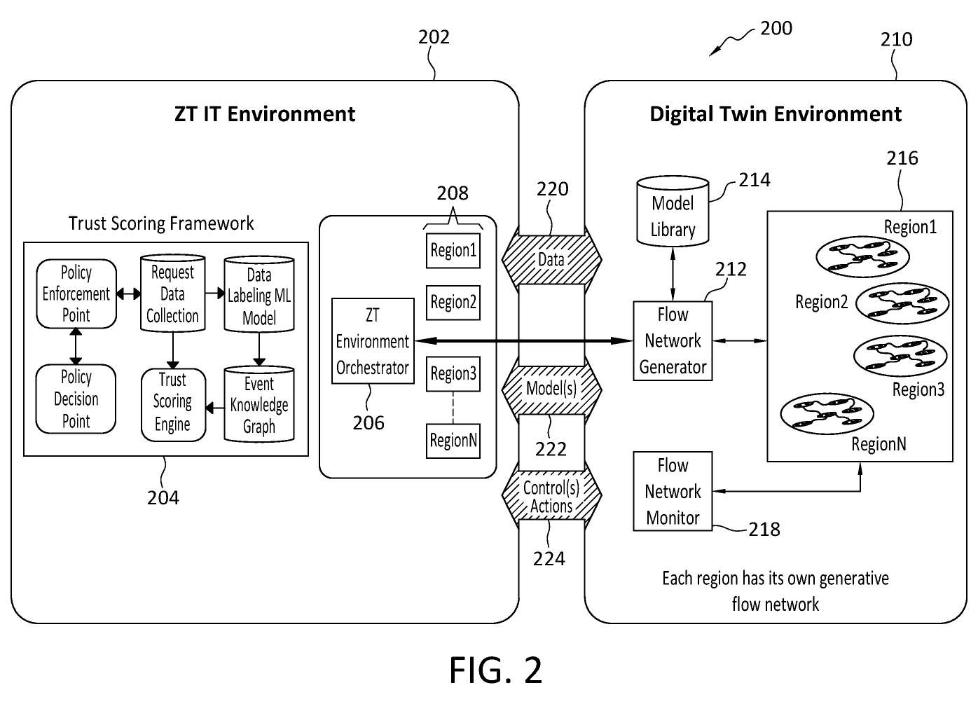

With reference now to the example of FIG. 2, an example schema 200 according to one embodiment is disclosed. As shown, a physical ZT environment 202 may comprise a trust scoring framework 204, examples of which are disclosed herein. The ZT environment 202 may further comprise a ZT environment orchestrator 206 that may, among other things, orchestrate workloads, and remedial and other actions, to various different regions 208 into which the ZT environment 202 may be divided.

The ZT environment 202 may be represented by a digital twin (DT) 210, examples of which are disclosed herein. The digital twin 210 may comprise various components including, but not limited to, a flow network generator 212, which may take the form of an ML model, that communicates with a model library 214, and with the ZT environment orchestrator 206. The digital twin 210 also comprises a respective digital twin 216 for each of the regions 208 of the ZT environment 202. These digital twins 216, which may be generated by the flow network generator 212 for example, may be monitored by a flow network monitor 218.

As further indicated in FIG. 2, various communications may take place between the ZT environment 202 and the digital twin environments 210. Such communications may include data 220, models 222, and control signals and remedial actions, collectively shown at 224.

As shown in FIG. 2, the generative flow networks 216 may be used to represent the structure, such as data, models, and relationships for example, of the ZT environment 202, which may be divided into regions 208 that may be, for example, functional and/or geographical in nature. The generative flow networks 216 may provide a mechanism to explain and trace the dynamic and live interactions ongoing in the systems and components of the ZT environment 202 including those related to implementing the Zero Trust principles. A generative flow network 216 may also provide the ability to track changes in the environment, to enable correlation of these changes to potential threats and make those changes explainable through causal relationships, such as the edges discussed above.

In operation, a DT representation, such as the DT environment 210, is generated to capture the structure of the ZT environment 202, where this structure includes the relationships between its components. The components and relationships may be represented, respectively, as nodes and edges of a generative flow network, examples of which are discussed in more detail below.

After the DT 210 has been created, a function may then be then executed by the flow network generator 212, leveraging the ZT environment 202 structure as represented by the DT 210, as input, to generate one or more corresponding generative flow networks 216 for a respective portion, such as a region 208, of the ZT environment 202. In an embodiment, each component of the ZT environment 202, or portion of the ZT environment 202, including the metadata of that component, is represented as a node in the newly generated flow network 216.

In an embodiment, the generative flow network 216 representation is instantiated from the ZT environment 202 (physical) in the digital twin 210 representation of the ZT environment 202. The flow network 216 in/for each region 208 may comprise its own model, which may comprise a neural network.

A separate flow network monitor 218 within the DT environment 210 is used to monitor the various paths within the (generative) flow network(s) 216, and gather information concerning the various components and their associated operations and relationships in the various flow networks 216. This monitoring information may enable better identification of potential vulnerabilities, ZT policy drift, and other circumstances, in the corresponding ZT environment 202. As well, inferencing may be performed on the information gathered during the monitoring process to gain insights into overall security posture of the ZT environment and dynamically apply changes in the ZT environment 202 (physical) as needed to mitigate the risk to the security posture of the ZT environment 202.

As disclosed herein, an embodiment may possess various useful features and aspects, although no embodiment is required to possess any of such features or aspects. The following examples are illustrative, but not exhaustive. For example, an embodiment supports multiple modalities and data sets including external variables such as physical and environmental that impact a physical ZT environment. As another example, generative flow network representation(s) enable decoupling of the more dynamic aspects of the ZT environment and make adaptive policy, and other, changes at both granular and macular levels, such as at an individual component level and an overall ZT environment level, respectively. In addition, the aggregation of these adaptive policy changes facilitates a more optimal approach of dynamic policy change in a ZT system.

### C. Flow network-based digital twin of a ZT environment for real time security posture

One example embodiment may assume the existence and availability of one or more generative flow networks, examples of which are disclosed herein, to represent one or more portions, or all, of a physical environment, such as a ZT environment for example. In example embodiments, these generative flow networks, or simply ‘flow networks,’ may be used to augment ZT environment observability and monitoring, beyond what a digital twin of the ZT environment could provide.

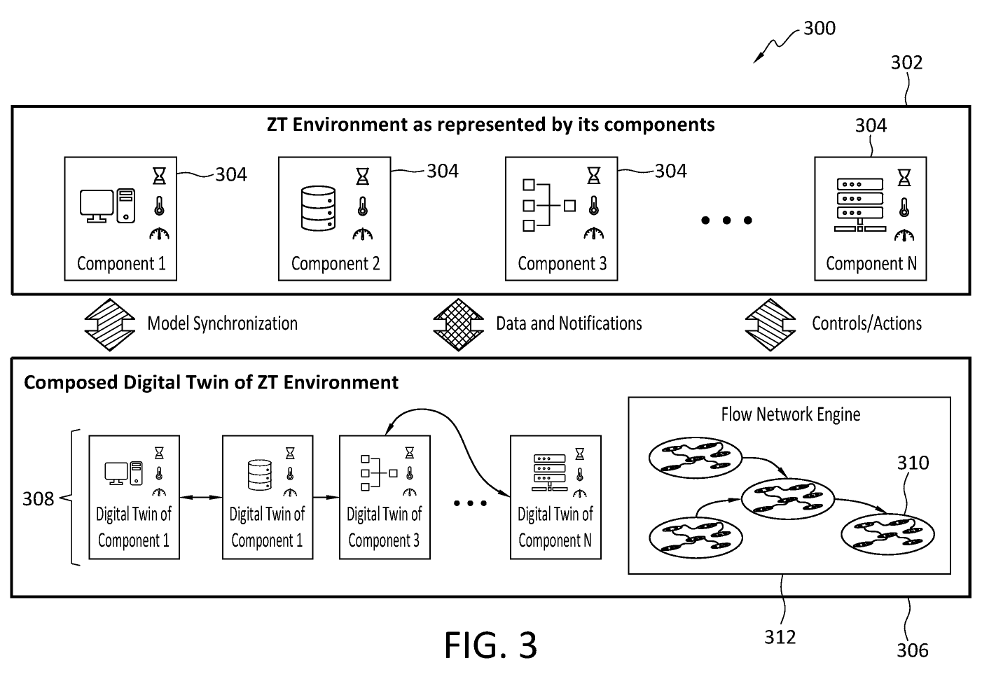

With the foregoing in view, FIG. 3 discloses an example schema 300 according to one example embodiment. As shown, a physical ZT environment 302 may comprise a variety of components 304 that may, for example, exchange data, and interoperate with each other. Each of the components 304 may comprise hardware and/or software. The ZT environment 302 may be represented, in whole or in part, by a DT 306. As disclosed herein, a DT, such as the DT 306 for example, may comprise respective CDTs 308 that represent one or more of the components 304 of the ZT environment 302. Additionally, or alternatively, the DT 306 may comprise one or more generative flow networks 310 that each represent a respective component 304 of the ZT environment 302. The generative flow networks 310 may be generated, monitored, and modified, by a flow network engine 312 which may comprise a flow network generator and a flow network monitor, examples of which are disclosed in FIG. 2 discussed above.

The DT 306 and the ZT environment 302 may communicate with each other for various purposes. For example, information from the ZT environment 302 may be used to update the component DTs 308, which may comprise ML models. As well, data and notifications may be exchanged by the DT 306 and the ZT environment 302. Finally, various controls/actions may be implemented/instantiated between the DT 306 and the ZT environment 302.

In an embodiment, the DT 306 may monitor the physical state of the ZT environment 302 in real time. A monitoring engine, such as the flow network monitor 218 disclosed in FIG. 2 for example, leverages a flow network 310 representation of the current state of the ZT environment 302, including, for example, power consumption, memory and storage usage, bandwidth consumption, and environmental threats, that can be detected if, for example, consumption of one or more of such resources increases above a defined threshold included in an assigned profile for the ZT environment 302.

A trust score framework, examples of which are disclosed in FIGS. 1 and 2, assigns risk scores to systems that are running the workloads and ensures that the systems are continuously kept in check. A trust score framework may be an element of the ZT environment 302, and/or may be incorporated into the DT 306. In this way, the trust score framework supports, for example, the investigation of the root cause of the increased power consumption or environmental changes to the sensors that feed data to the DT 306 to assess if this is an attack, such as a denial of service (DoS or DDoS) attack, or an actual failure of the sensor component. In an embodiment, the DT 306 and the ZT environment 302 are continuously synchronized, that is, the DT 306 is synchronized to the configuration and operation of the ZT environment 302, to enable high fidelity determinations of the state of each component of the ZT environment 302 in real time.

As disclosed herein, an embodiment may possess various useful features and aspects, although no embodiment is required to possess any of such features or aspects. The following examples are illustrative, but not exhaustive. For example, in an embodiment, the augmentation of the DT 306 with generative flow network representation(s) 310 enables a more granular, that is, component level, real-time monitoring of the physical ZT system 302. Thus, an embodiment may extend the scope of the observability and monitoring to additional factors and coverage of external and unknown variables to assess, at various levels of granularity, the security posture of the ZT environment 302. In an embodiment, generative flow networks 310 applied to trust and security in complex ZT environments 302 enable the implementation of causality and explanation, while offering lineage and traceability during an operational mode of the ZT environment 302.

### D. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

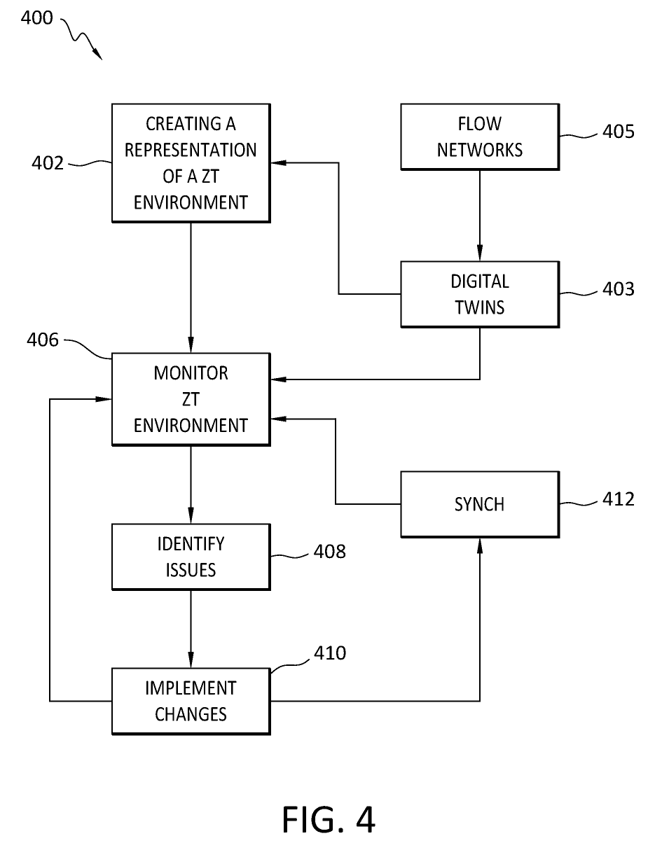

Directing attention now to FIG. 4, an example method 400 according to one embodiment is disclosed. The example method 400 may begin with creation 402 of a representation of a physical ZT environment whose security posture is to be monitored and assessed on an ongoing basis. In an embodiment, the representation created at 402 may include one or more digital twins 403. In an embodiment, one or more of the digital twins 403 may be augmented to include a respective flow network 405.

The representation of the physical ZT environment may be used to monitor 406 any and all aspects of the physical ZT environment. This monitoring 406 may be performed on an ongoing basis. The monitoring 406 may be performed in a non-intrusive manner with respect to the physical ZT environment and its operations.

As well, the data obtained by the monitoring 406 may be assessed by a trust scoring framework, possibly as part of the monitoring 406, for what that data indicates about the security posture of the components and operations of the physical ZT environment. The representation may then generate and transmit respective TSF scores for components of the physical ZT environment to an aggregation service for generation of an aggregate trust score for the physical environment.

Based on data, metadata, and other information gathered during the monitoring 406, one or more issues concerning aspects of the physical ZT environment may be identified 408. Such aspects may include, but are not limited to, the structure, operations, relationships, and data, of the physical ZT environment.

Because the monitoring 406 may be performed on a real-time, ongoing basis, this approach may enable timely, and more effective, identification 408 of problems and issues in the physical ZT environment. In response to identification 408 of issues, corresponding remedial actions may be automatically identified, and implemented 410, in the physical ZT environment.

After, or while, the changes are made 410, synchronization 412 may be performed to ensure that the representation of the physical ZT environment accurately reflects the actual structure and operation of the physical ZT environment, as modified 410. That is, the changes 410 may be synchronized 412 to the representation, possibly in real time as the changes are implemented 410 to the physical environment. In this way, the representation of the physical ZT environment remains up to date with the current structure and operations of the physical environment. As noted herein, the changes 410 may not necessarily be implemented in the physical ZT environment, but only in the representation, as a way to perform and analyze hypothetical circumstances.

### E. Further Example Embodiments

Following are some further example embodiments. These are presented only by way of example and are not intended to limit the scope of this disclosure or the claims in any way.

Embodiment 1. A method for assessing a security posture of a physical zero trust environment and identifying corresponding actions to be taken with respect to the physical zero trust, comprising: creating a representation of a physical ZT (zero trust) environment, and the representation comprises one or more digital twins that each correspond to a respective component of the physical ZT environment; monitoring, with the digital twins, the components and operation of the physical ZT environment; collecting, by the digital twins, data concerning the components and the operation of the physical ZT environment; and implementing, automatically, a change to the physical ZT environment based on the data collected by the digital twins.

Embodiment 2. The method as recited in any preceding embodiment, wherein each of the digital twins is associated with a respective trust scoring framework that generates a respective trust score for the component monitored by that digital twin.

Embodiment 3. The method as recited in any preceding embodiment, wherein one or more of the digital twins is synchronized in real time with a respective portion of the physical ZT environment when the monitoring indicates that the portion of the physical ZT environment has changed.

Embodiment 4. The method as recited in any preceding embodiment, wherein the digital twins each comprise a respective ML (machine learning) model.

Embodiment 5. The method as recited in any preceding embodiment, wherein when the data indicates a problem in the physical ZT environment, a corresponding remedial action is identified and implemented, and one or more of the digital twins re-synchronized with the physical ZT environment.

Embodiment 6. The method as recited in any preceding embodiment, wherein each of the digital twins comprises a respective generative flow network.

Embodiment 7. The method as recited in embodiment 6, wherein the generative flow networks are used to track changes and interactions occurring with respect to the components of the physical ZT environment.

Embodiment 8. The method as recited in any of embodiments 6-7, wherein data concerning the physical ZT environment is collected by the generative flow networks and is indicative of a security posture of the physical ZT environment.

Embodiment 9. The method as recited in any of embodiments 6-8, wherein the generative flow networks collect data concerning the physical ZT network, and the data collected by the generative flow networks is more granular than the data collected by the digital twins.

Embodiment 10. The method as recited in any of embodiments 6-9, wherein the change to the physical ZT environment is based on data collected by the digital twins, and data collected by the generative flow networks.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

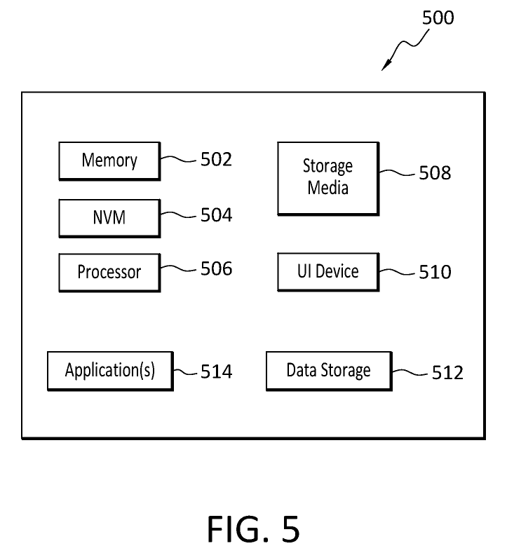

With reference briefly now to FIG. 5, any one or more of the entities disclosed, or implied, by FIGS. 1-4, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for assessing a security posture of a physical zero trust environment and identifying corresponding actions to be taken with respect to the physical zero trust, comprising:
creating a representation of a physical ZT (zero trust) environment, and the representation comprises one or more digital twins that each correspond to a respective component of the physical ZT environment;
monitoring, with the digital twins, the components and operation of the physical ZT environment;
collecting, by the digital twins, data concerning the components and the operation of the physical ZT environment; and
implementing, automatically, a change to the physical ZT environment based on the data collected by the digital twins.

2. The method as recited in claim 1, wherein each of the digital twins is associated with a respective trust scoring framework that generates a respective trust score for the component monitored by that digital twin.

3. The method as recited in claim 1, wherein one or more of the digital twins is synchronized in real time with a respective portion of the physical ZT environment when the monitoring indicates that the portion of the physical ZT environment has changed.

4. The method as recited in claim 1, wherein the digital twins each comprise a respective ML (machine learning) model.

5. The method as recited in claim 1, wherein when the data indicates a problem in the physical ZT environment, a corresponding remedial action is identified and implemented, and one or more of the digital twins re-synchronized with the physical ZT environment.

6. The method as recited in claim 1, wherein each of the digital twins comprises a respective generative flow network.

7. The method as recited in claim 6, wherein the generative flow networks are used to track changes and interactions occurring with respect to the components of the physical ZT environment.

8. The method as recited in claim 6, wherein data concerning the physical ZT environment is collected by the generative flow networks and is indicative of a security posture of the physical ZT environment.

9. The method as recited in claim 6, wherein the generative flow networks collect data concerning the physical ZT network, and the data collected by the generative flow networks is more granular than the data collected by the digital twins.

10. The method as recited in claim 6, wherein the change to the physical ZT environment is based on data collected by the digital twins, and data collected by the generative flow networks.

11. A non-transitory storage medium having stored therein instructions that are executable by one or more hardware processors to perform operations comprising:
creating a representation of a physical ZT (zero trust) environment, and the representation comprises one or more digital twins that each correspond to a respective component of the physical ZT environment;
monitoring, with the digital twins, the components and operation of the physical ZT environment;
collecting, by the digital twins, data concerning the components and the operation of the physical ZT environment; and
implementing, automatically, a change to the physical ZT environment based on the data collected by the digital twins.

12. The non-transitory storage medium as recited in claim 11, wherein each of the digital twins is associated with a respective trust scoring framework that generates a respective trust score for the component monitored by that digital twin.

13. The non-transitory storage medium as recited in claim 11, wherein one or more of the digital twins is synchronized in real time with a respective portion of the physical ZT environment when the monitoring indicates that the portion of the physical ZT environment has changed.

14. The non-transitory storage medium as recited in claim 11, wherein the digital twins each comprise a respective ML (machine learning) model.

15. The non-transitory storage medium as recited in claim 11, wherein when the data indicates a problem in the physical ZT environment, a corresponding remedial action is identified and implemented, and one or more of the digital twins re-synchronized with the physical ZT environment.

16. The non-transitory storage medium as recited in claim 11, wherein each of the digital twins comprises a respective generative flow network.

17. The non-transitory storage medium as recited in claim 16, wherein the generative flow networks are used to track changes and interactions occurring with respect to the components of the physical ZT environment.

18. The non-transitory storage medium as recited in claim 16, wherein data concerning the physical ZT environment is collected by the generative flow networks and is indicative of a security posture of the physical ZT environment.

19. The non-transitory storage medium as recited in claim 16, wherein the generative flow networks collect data concerning the physical ZT network, and the data collected by the generative flow networks is more granular than the data collected by the digital twins.

20. The non-transitory storage medium as recited in claim 16, wherein the change to the physical ZT environment is based on data collected by the digital twins, and data collected by the generative flow networks.
